(19) United States
(12) Patent Application Publication
(10) Pub. No.: US 2007/0265969 A1
(43) Pub. Date: Nov. 15, 2007

(54) COMPUTERIZED MANAGEMENT OF MEDIA DISTRIBUTION AGREEMENTS

(75) Inventors: Justyna Horwat, San Francisco, CA (US); Max Muller, San Jose, CA (US); Gregory Robbin, Mountain View, CA (US); Eric John Gray, Sunnyvale, CA (US); Jonathan B. Leffert, Mountain View, CA (US); Matti J. Railo, San Jose, CA (US); Sean K. Smith, San Francisco, CA (US)

Correspondence Address: TECHNOLOGY & INNOVATION LAW GROUP, PC, ATTN: 101, 19200 STEVENS CREEK BLVD., SUITE 240, CUPERTINO, CA, 95014, US

(73) Assignee: Apple Computer, Inc.

(21) Appl. No.: 11/622,923

(22) Filed: Jan. 12, 2007

Related U.S. Application Data
(60) Provisional application No. 60/800,843, filed on May 15, 2006.

(51) Int. Cl. H04L 9/00

(52) U.S. Cl. 705/51

(57) ABSTRACT

Methods and systems for managing media distribution are disclosed. Advantageously, the management of media distribution can be substantially computer implemented and include management of media distribution agreements. The management of media distribution agreements can operate to manage the creation and/or renewal of media distribution agreements in an automated and efficient manner. The methods and systems for management of media distribution can also take appropriate action when an established media distribution agreement expires.

### CROSS-REFERENCE TO RELATED APPLICATIONS

This application claims priority of U.S. Provisional Patent Application No. 60/800,843, filed May 15, 2006, and entitled “TECHNIQUES AND SYSTEMS FOR ELECTRONIC SUBMISSION OF MEDIA CONTENT” [Attorney Docket No. APL1 P502P], which is hereby incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

1. Field of the Invention

The present invention relates to electronic distribution of media and, more particularly, to management of agreements concerning distribution of media items.

2. Description of the Related Art

Traditionally, music has been purchased at music stores or music departments of larger stores. A consumer will visit the music store or department and manually browse for albums or compact discs (CDs) of interest. Often, the music in the music store or department is categorized by genre, and then indexed by artist. For example, genre can include rock, country, pop, soul, jazz, etc. After the consumer selects an album or CD of interest, the consumer proceeds to a check-out register to pay for the album or CD being purchased.

In recent years, music delivery or distribution over the Internet has become popular. Due to the advances in efficient file formats, such as MP3 and MPEG4, the size of media files have become small enough to make their download via the Internet practical. Also, technological advances have led to higher-speed Internet connections and lower cost of memory. The combination of these advances make downloading media files, such as for music and videos, manageable and not too time consuming.

Today, various online media distribution sites permit virtual visitors to electronically search or browse various media items (e.g., albums, songs, ring tones, videos, etc.) as well as purchase and download such media items via the Internet (e.g., World Wide Web). However, in order for the media items to be offered for purchase and download, the electronic content for the media items must first be provided to the media distribution sites. Conventionally, content providers enter into contracts with media distribution sites so that media items of the content providers can be offered for purchase and download at the media distribution sites. Unfortunately, media distribution sites do not provide robust systems to manage these contracts. For example, contracts may not be timely renewed and manual interaction may be required to cease the purchase and download of media items corresponding to content providers having expired contracts. These and other problems are exacerbated by the large number of content providers that distribute media content with a media distribution site. As a result, representatives of the media distribution site face substantial burdens and difficulties in attempting to manage the contracts associated with the many content providers.

Thus, there is a need for improved approaches to manage distribution of media items from an online media distribution site.

### SUMMARY OF THE INVENTION

Methods and systems for managing media distribution are disclosed. Advantageously, the management of media distribution can be substantially computer implemented and include management of media distribution agreements. The management of media distribution agreements can operate to manage the creation and/or renewal of media distribution agreements in an automated and efficient manner. The methods and systems for management of media distribution can also take appropriate action when a media distribution agreement is approved as well as when the media distribution agreement expires.

The invention can be implemented in numerous ways, including as a method, system, device, apparatus, graphical user interface, or computer readable medium. Several embodiments of the invention are discussed below.

As a computer-implemented method for automated processing of media contracts for a media content provider and a media distribution system, one embodiment of the invention includes at least the acts of: receiving a media contract request from a media content provider; determining a document set to be utilized for the media contract request; personalizing the document set for the content provider; and sending the personalized document set to the content provider.

As a computer-implemented method for notifying a content provider to renew a media contract with a media distribution system, one embodiment of the invention includes at least the acts of: determining at least one content provider having at least one contract that is soon to expire; producing a notification message to inform the content provider that the contract is soon to expire unless renewed; and sending the notification message to the content provider.

As a computer-implemented method for renewing media contracts between content providers and a media distribution system, one embodiment of the invention includes at least the acts of: identifying at least one media contract to be renewed, the media contract being between a content provider and the media distribution system; determining a document set for renewal of the at least one media contract to be renewed; personalizing the document set for the content provider; sending the personalized document set to the content provider; storing document information corresponding to the personalized document set into a contract database; updating the contract database when the personalized document set is executed and returned; enabling submission and distribution of media content to the media distribution system; and notifying the content provider that they are eligible to submit content to the media distribution system for distribution.

As a graphical user interface for renewing a contract, one embodiment of the invention includes at least: an expiration warning area that presents an expiration warning; renewal instructions area that presents renewal instructions; and a listing of one or more existing contracts that can be renewed. For each of the existing contracts in the listing, the listing of existing contracts includes a contract region and a contract type.

As a computer readable medium including at least computer program code for automated processing of a media distribution agreement between a media content provider and a media distribution system, one embodiment of the invention includes at least: computer program code for receiving a media distribution agreement request from a media content provider; computer program code for determining a media contract to be utilized for the media distribution agreement request; computer program code for personalizing the media contract for the content provider; and computer program code for sending the personalized media contract to the content provider.

As a media management system for managing media content, one embodiment of the invention includes at least: an agreement management system that manages media distribution agreements for the media management system; and a media distribution system that manages electronic distribution of media content associated with content providers to purchasers over a network. The agreement management system can include one or more of: (i) a notification manager configured to send notifications to those content providers with media distribution agreements that are soon to expire; (ii) an agreement renewal manager configured to facilitate renewal of media distribution agreements prior to their expiration; (iii) an agreement expiration manager configured to indicate an expiration status when one or more of the media distribution agreements expire before being renewed; and (iv) a database that stores agreement information on the media distribution agreements, the agreement information including at least descriptive information and a status indication for each of the media distribution agreements.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1A is a block diagram of a media submission and distribution system according to one embodiment of the invention.

FIG. 1B is a block diagram of a media management system according to one embodiment of the invention.

FIG. 1C is a schematic diagram of a contract database organization according to one embodiment of the invention.

FIG. 2A is a flow diagram of a contract delivery process according to one embodiment of the invention.

FIG. 2B is a flow diagram of a contract completion process according to one embodiment of the invention.

FIG. 3A illustrates an exemplary e-mail message that can be sent to a content provider (i.e., user) to invite the content provider to apply for usage of the media distribution system.

FIG. 3B illustrates an exemplary contract request screen according to one embodiment of the invention.

FIG. 3C illustrates a representative e-mail message that can be sent to a content provider when they are approved for a new contract (e.g., media distribution agreement).

FIGS. 3D and 3E illustrate a representative e-mail message sent to a content provider.

FIG. 4 is a flow diagram of a contract renewal notification process according to one embodiment of the invention.

FIG. 5A is a diagram of a retrieval notification system according to one embodiment of the invention.

FIG. 5B is a flow diagram of a renewal notification process.

FIG. 6A is an exemplary e-mail message that can be sent to a content provider (i.e., user) to inform them that one or more of their existing contracts are due to expire in several months.

FIG. 6B is an exemplary contract renewal screen according to one embodiment of the invention.

FIG. 6C is an exemplary contract amendment screen according to one embodiment of the invention.

FIGS. 7A and 7B are flow diagrams of a contract renewal process according to one embodiment of the invention.

FIG. 8 is an exemplary e-mail message that can be sent to a content provider (i.e., user) to inform them that one or more of their existing contracts has been successfully renewed.

### DETAILED DESCRIPTION OF THE INVENTION

The invention pertains to improved methods and systems for managing contracts. Advantageously, the contract management provided by the invention can be substantially computer implemented. More particularly, the contract management can operate to manage the creation of contacts in an automated and efficient manner. Further, the contract management can also operate to manage the renewal and expiration of contacts in an automated and efficient manner. The method and system for contract management can also take appropriate action when a contract is approved as well as when the contract expires.

Users can interact online with the contract management system to create or renew contracts. In one embodiment, the contracts being managed pertain to media content that is being made available for distribution, such as by an online media distribution system (e.g., online media hosting site). Management of the contracts in an automated manner facilitates automated control over submission and/or distribution of media content with respect to the online media distribution system.

In one embodiment, the contracts being managed can be media contracts, i.e., contracts that concern media contract. The media contract being governed by such contracts can, for example, be text, audio, video, and/or image data. More generally, as used herein, contracts are legal agreements between parties (e.g., a content provider and a media content distributor/media distribution system). Hence, the contracts can also be referred to herein as agreements (e.g., media distribution agreements).

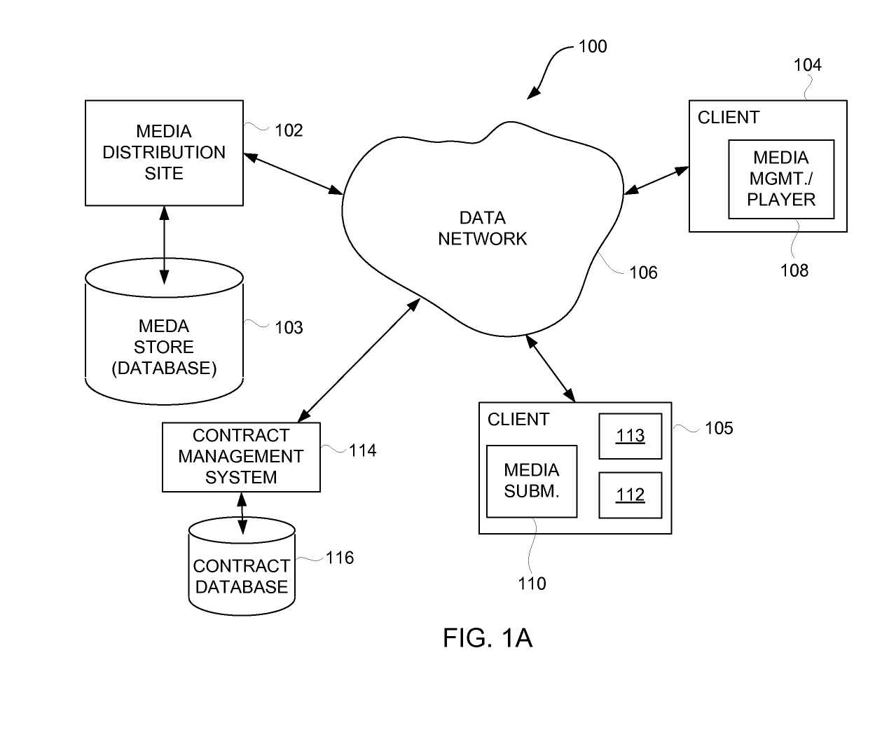

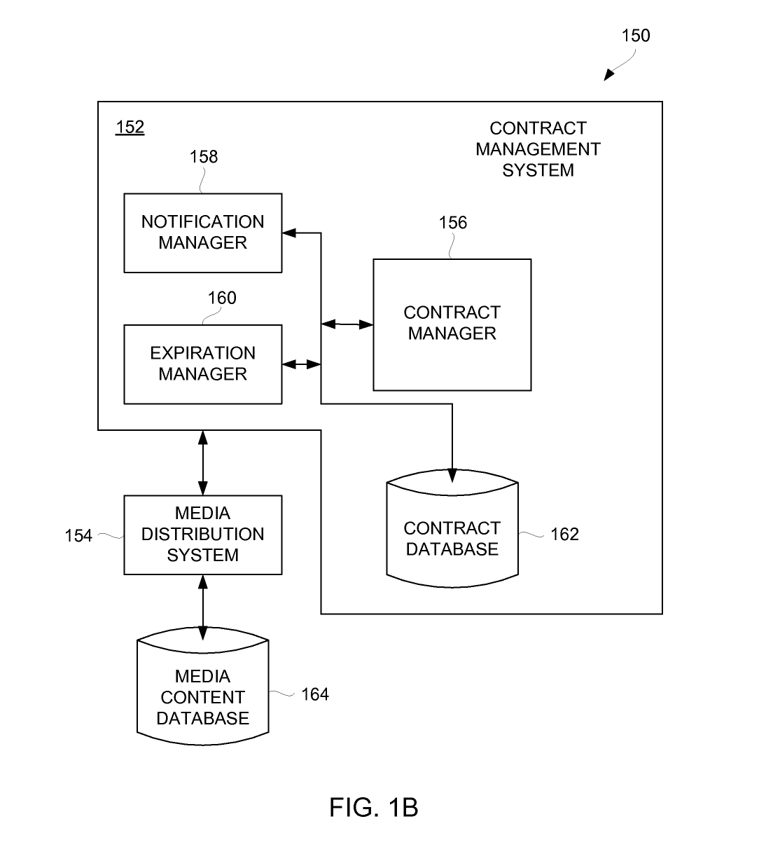

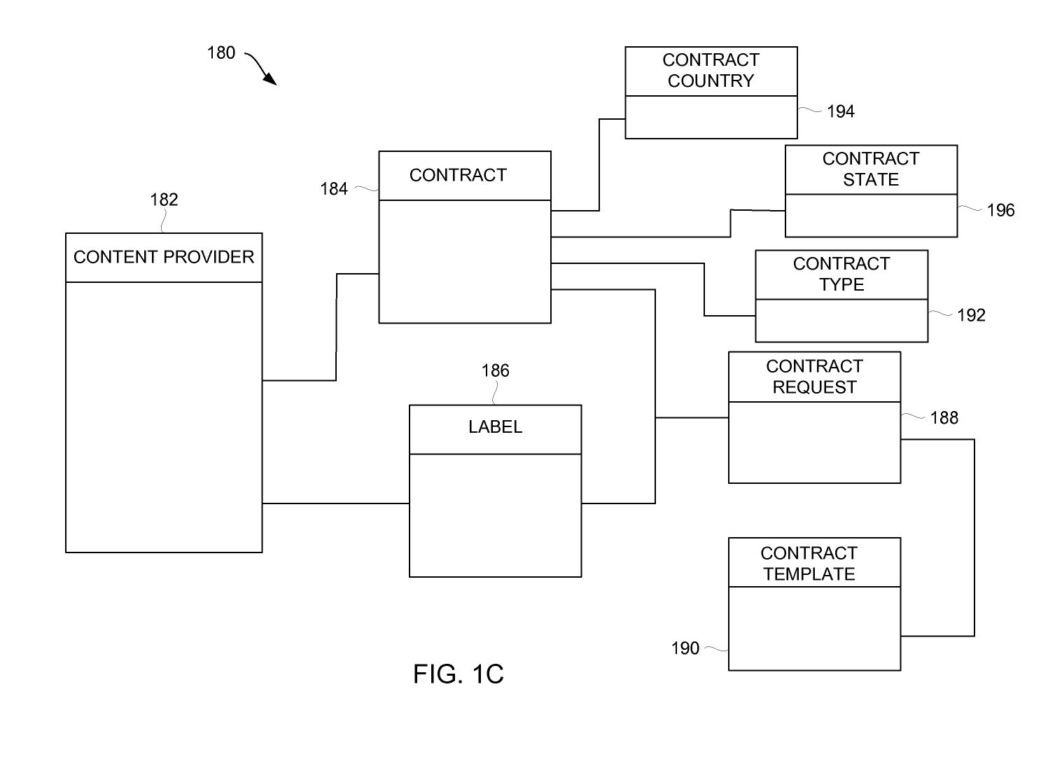

Embodiments of various aspects of the invention are discussed below with reference to FIGS. 1A-7B. However, those skilled in the art will readily appreciate that the detailed description given herein with respect to these figures is for explanatory purposes as the invention extends beyond these limited embodiments.

A media submission and distribution system can provide contract management. The contract management can assist with contract formation and/or contract renewal. The ability to submit media and/or distribute media can also be dependent on contract status. For example, media submission and/or distribution can be automatically authorized or declined depending on contract status.

FIG. 1A is a block diagram of a media submission and distribution system 100 according to one embodiment of the invention. The media submission and distribution system 100 includes a media distribution system 102. The media distribution system 102 coordinates submission (receipt), storage and purchase of media items. The media distribution system 102 stores media items in a media store 103. In one embodiment, the media store 103 is a database (media database). The media store 103 provides mass storage of the numerous media items that are available for purchase. Once purchased, the media items can be accessed from the media store 103 over a data network 106 by way of the media distribution system 102.

The media submission and distribution system 100 also includes a first client 104 and a second client 105. Typically, the media submission and distribution system 100 would include a plurality of different clients 104, 105. The first client 104 includes a media management/player 108 for playing and/or managing media items. The second client 105 includes a media submission program 110 for submitting media items to the media distribution system 102. Some clients can also include both the media management/player 108 and the media submission program 110. The media management/player 108 is an application program (e.g., software application) that operates on the first client 104, which is a computing device. One example of a suitable media management/player 108 is iTunes® offered by Apple Computer, Inc. The first client 104 is coupled to the media distribution system 102 through the data network 106. Hence, any of the first clients 104 can interact with the media distribution system 102 to review, purchase and/or manage media items. The client 105 can also include a network browser 112 and an electronic mail program 113.

The media submission program 110 is also an application program (e.g., software application) that operates on the second client 105, which is a computing device. The media submission program 110 is used to submit media items to the media distribution system 102. Additional information on media submission programs is provided in U.S. patent application Ser. No. 11/609,815, filed Dec. 12, 2006, and entitled “TECHNIQUES AND SYSTEMS FOR ELECTRONIC SUBMISSION OF MEDIA FOR NETWORK-BASED DISTRIBUTION” [Attorney Docket No. APL1 P508], which is hereby incorporated herein by reference.

Although the media management/player 108 and the media submission program 110 are shown in FIG. 1A as separate programs, it should be understood that such programs can be integrated into a single program and reside on the same client.

In the media submission and distribution system 100 shown in FIG. 1A, the media items are submitted to the media distribution system 102 by way of the media submission program 110. The media distribution system 102 can pertain to a media distribution site (or online media hosting site).

The media items that have been submitted (e.g., via the second client 105) are processed and then stored in the media store 103. Thereafter, the stored media items are available to be purchased from the media distribution system 102. Upon purchasing a particular media item, the media distribution system 102 permits the media content for the particular media item to be retrieved from the media store 103 and then delivered (e.g., downloaded) from the media distribution system 102 to the corresponding client 104 through the data network 106. In this regard, the media distribution system 102 obtains the media content corresponding to the particular media item from the media store 103 and transmits (e.g., downloads) such content through the data network 106 to the client 104. The downloaded media content can then be stored on the client 104. In one embodiment, the downloaded media content is encrypted as received at the client 104 but is decrypted and then perhaps re-encrypted before persistent storage on the client 104. Thereafter, the media management/player 108 can present (e.g., play) the media content at the client 104.

The media submission and distribution system 100 allows a user of the client 104 to utilize the media player 108 to browse, search or sort through a plurality of media items that can be purchased from the media distribution system 102. The media management/player 108 may also allow the user to preview a media item. In the event that the user of the media management/player 108 desires to purchase a particular media item, the user (via the media management/player 108) and the media distribution system 102 can engage in an online commerce transaction in which the user pays for access rights to the particular media item. In one embodiment, a credit card associated with the user is credited for the purchase amount of the particular media item.

The submission and purchase of the media items can be achieved over a data network 106. In other words, the submission and purchase of the media items can be achieved online. The purchase of media items online can also be referred to as electronic commerce (e-commerce). In one embodiment, the data network 106 includes at least a portion of the Internet. The clients 104 can vary with application but generally are computing devices that have memory storage. Often, the clients 104 are personal computers or other computing devices (media players, Portable Digital assistants (PDAs), mobile phones, etc.) that are capable of storing and presenting media to their users.

The connections through the data network 106 between the media distribution server 102 and the clients 104, 105 can be through secure connections, such as Secure Sockets Layer (SSL). Further, the media content can be re-encrypted prior to storage at the client 104 such that downloaded media content is not stored in the clear, but is instead stored in an encrypted manner.

The media submission and distribution system 100 further includes a contract management system 114. The contract management system 114 couples to the data network 106. The contract management system 114 also has access to a contract database 116. The contract management system 114 provides management of contracts for the media distribution system 102. The client 105 can interact with the contract management system 114 via the data network 100 so as to request a new contract for media submission or to renew an existing contract pertaining to media submission. A content provider can communicate with the contract management system 114 via the client 105 through use of the network browser 112 or the media submission program 110.

The media submission and distribution system 100 allows content providers to submit media to the media distribution system 102. In this regard, the media submission program 110 operating on the client 105 can submit media content to the media distribution system 102 over the data network 106. The media distribution system 102 interacts with the contract management system 114 for various reasons. One reason is that the media distribution system 102 verifies that the media (media content) being submitted to the media distribution system 102 is done so by an authorized content provider. Being authorized means that the content provider is under an existing media distribution agreement (i.e., contract) with the media distribution system 102. The contract management system 114 stores information concerning media contracts for all authorized content providers of the media distribution system 102. Hence, the media distribution system 102 can interact with the contract management system 114 to determine whether a content provider seeking to submit media content to the media distribution system 102 is authorized. In one embodiment, authorization of a content provider can be dependent on the type of content that the content provider seeks to submit. When the content provider is determined not to have an existing media contract for distribution of media, the media distribution system 102 can decline to distribute any media content provided by the content provider. Moreover, the media distribution system 102 can decline to accept receipt of any of media content whose submission is being attempted by the content provider.

The media distribution system 102 and the contract management system 114 can be provided on the same or different server computers. Indeed, in one embodiment, the media distribution system 102 and the contract management system 114 can be integrated together. Regardless of whether the media distribution system 102 and the contract management system 114 are provided on the same or different computers, the combination of the media distribution system 102 and the contract management system 114 can be referred to as a media management system.

The media distribution system 102 can serve a wide range of geographic territories. In the case of media content, there are often separate rights for different territories. For example, one party may own the rights for media distribution in United States, where another party may own the rights for media distribution in China. Still further, the media distribution system 102 may operate to distribute various different types of media. For example, the media distribution system 102 (e.g., an online media store) can offer for sale music (songs or albums), audiobooks, music videos, videos, audiobooks, games, etc. As such, the contract management system 114 according to one embodiment can separately manage the contract rights in different regions or territories as well as for different media content types. The contract management system is largely automated by the contract management system 114.

A contract request process according to one embodiment of the invention can be described as follows. Initially, a user, such as a label (e.g., music label), can be invited to interact with the contract management system 114 so as to create an account and request a contract. If approved, the contract management system 114 will produce a contract and transmit it to the user. Once the contract is signed and returned, and the user receives final approval, the user is permitted to submit content to the media distribution system 102. Methods and systems for submitting content to the media distribution system 102 were discussed above. The digital content that is submitted is then made available for distribution in those territories under which the user (e.g., label) is under contract.

When a user (e.g., label) is creating an account, an online form can be utilized to receive data from the user, who is now an applicant. The network address for the online form can be provided to the applicant via e-mail. For example, the e-mail message can include a link that pertains to a uniquely encrypted URL. As the applicant enters data into the online form, the data can be captured electronically by the system and stored at the server in a database. The data can subsequently be used to minimize the data entry required by the applicant for subsequent documents, such as contracts. After the account is created, the applicant can request to enter a contract. If the media distribution system 102, or a digital content distributor associated with the media distribution system 102, approves the applicant for a contract, contract documents can be dynamically generated by the system and then transmitted to the applicant. The applicant can then sign and return the contracts by regular mail, electronic mail, facsimile, electronically, etc. The contract information is also stored in the database. For example, the contract information can include (i) content types that the contract is associated with, (ii) territories, (iii) pricing tier, (iv) expiration date, (v) mechanicals (i.e., royalties), (vi) start date, and the like. Once the signed contract is received by the digital content distributor/media distribution system 102, the contract can undergo a business and/or legal review. The applicant can also undergo a financial review, e.g., so that a financial account in a financial system (e.g., SAP) can be configured to track royalties that are associated with the digital content. Regardless of the various reviews, once the contract is approved, the content provider can be permitted to upload media content to the digital content distributor in accordance with their contract.

Accordingly, when digital content is submitted for distribution by a content provider, the digital content is verified to be under an existing contract between the content provider (submitter) and the digital content distributor. In the event that the digital content is not deemed to be under an existing contract, the digital content will not be made available for distribution at the media distribution system 102. This normally requires access to the contract database 116 that stores the contract information. In this regard, availability of digital content for distribution may in some cases be frequently checked; hence, it may be advantageous to cache certain database information so that the checks are able to be performed rapidly and without needing to access the database on a frequent basis.

Given that contract information is stored within the contract database 116, the contract management system 114 can also monitor contracts to ensure that they remain updated. In other words, when existing contracts are near their expiration date, the contract management system 114 can take appropriate action to notify the content providers (e.g., labels) that their contracts will soon expire. The distribution of the digital content associated with the content provider can be automatically restricted or prevented in the event that a content provider's contract associated with such content expires. Hence, the contract management system 114 can remind content providers that they needed to renew their contract in order for their content to continue to be available for distribution. In the event that a content provider desires to renew their contract, they can interact via an online means with the contract management system 114 to request and receive a renewed contract. The renewed contract can be electronically transmitted to the user, such as in PDF format.

In general, the contract management system 114 can monitor and determine when to seek renewal of existing contracts, whether agreements are in effect with particular content providers, and what regions content providers are authorized to distribute (i.e., sell) in, and what types of content the content providers are authorized to distribute.

FIG. 1B is a block diagram of a media management system 150 according to one embodiment of the invention. The media management system 150 includes a contract management system 152 and a media distribution system 154. The contract management system 152 manages creation and renewal of media contracts for numerous different providers of media content. The contract management system 152 can also be used to assist with the approval of contracts, determining whether media content is under contract, etc. The contract management system 152 includes a contract manager 156 that manages creation/renewal of media contracts. The contract manager 156, the notification manager 158 and the expiration manager 160 can all access a contract database 162. The contract database 162 can store descriptive information concerning the media contracts. The contract information can include start date, expiration date, content provider, media type, contract status, etc.

After initial contracts have been set up with content providers, at some point these contracts will expire. Since the contract database 162 maintained by the contract management system 152 stores information on expiration dates of the various contracts, the contract management system 152 is aware of when contracts will expire for particular content providers. As a result, the media management system 150 can also monitor contract expiration and manage contract renewal.

In the case of contract renewal, the contract manager 156 can interact with a notification manager 158 and an expiration manager 160. The notification manager 158 determines whether notifications are to be sent to content providers, such as a notification of an expiring media contract or notification of a renewed contract. The expiration manager 160 operates to determine when a media contract has expired and then take appropriate action, such as preventing further distribution of media content that was previously authorized by the now expired media contract.

The contract management system 152 is coupled to the media distribution system 154. Typically, the media distribution system 154 interacts with contract management system 152 to determine whether a content provider has an appropriate contract with the media distribution system 154. The media distribution system 154 also interacts with the media content database 164. The media content database 164 stores media content that is available for distribution by the media distribution system 154. In one embodiment, the media distribution system 154 supports an online media store from which numerous users can purchase media content over a data network (such as the Internet).

FIG. 1C is a schematic diagram of a contract database organization 180 according to one embodiment of the invention. The contract database organization can be used with the contract database 116 illustrated in FIG. 1A or the media content database 164 illustrated in FIG. 1B. The contract database organization 180 includes a content provider table 182, a contract table 184, a label table 186, a contract request table 188 and a contract template 190. The content provider table 182 stores information concerning the content provider. The content provider table 182 can include fields that can store information descriptive of the content provider or fields containing information on media content of the content provider, or authorizations for features used by the content provider. The contract table 184 contains information that describes the characteristics or features of a media contract. The contract table 184 can link to other tables that store one or more characteristics of media contracts. As shown in FIG. 1C, the contract table 184 can link to a contract type table 192, a contract country table 194 and a contract state table 196. The contract type table 192 can indicate the one or more types of media that are covered by the contract. The contract country table 194 can indicate the one or more countries (territories or regions) that are covered by the contract. The contract state table 196 can indicate a state of the contract. Exemplary states can include sent, received, and active. Typically, a given content provider will be associated with a plurality of different contracts. Hence, the contract table 184 can be replicated for each different contract with the content provider. The label table 186 contains information pertaining to a media label. Information associated with the media label can be descriptive of the media label or can pertain to management of media contracts with the media label. The contract request table 108 includes information regarding contracts that have been requested, including attributes of the contracts that have been requested. The contract template table 190 includes information concerning contract templates that have been utilized by the system when requesting contracts.

According to one aspect, a contract management system processes and manages creation of media contracts. The interested parties can vary depending upon application. One application of the contract management system is for media submission to a media distribution system operated by a digital content distributor. Such a system can be used by content providers (e.g., music labels) to submit media content to a digital content distributor which may operate a media distribution system (e.g., an online media store). Typically, the digital content distributor requires contracts with each of the music labels. The contracts authorize the digital content distributor to sell or otherwise distribute (via the media distribution system) media content that is controlled by the content providers.

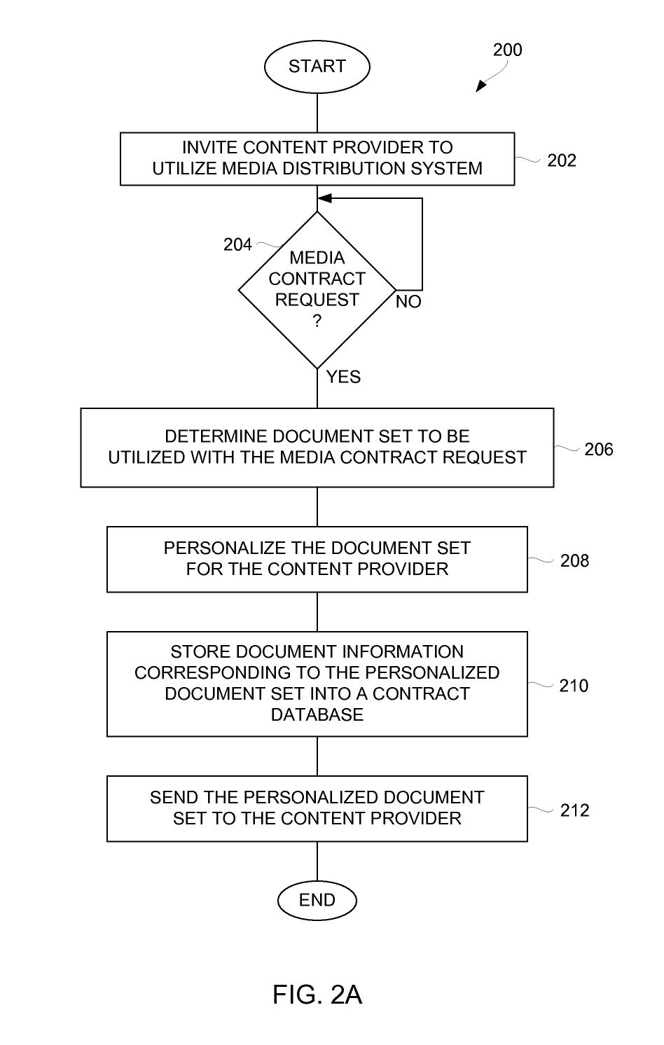

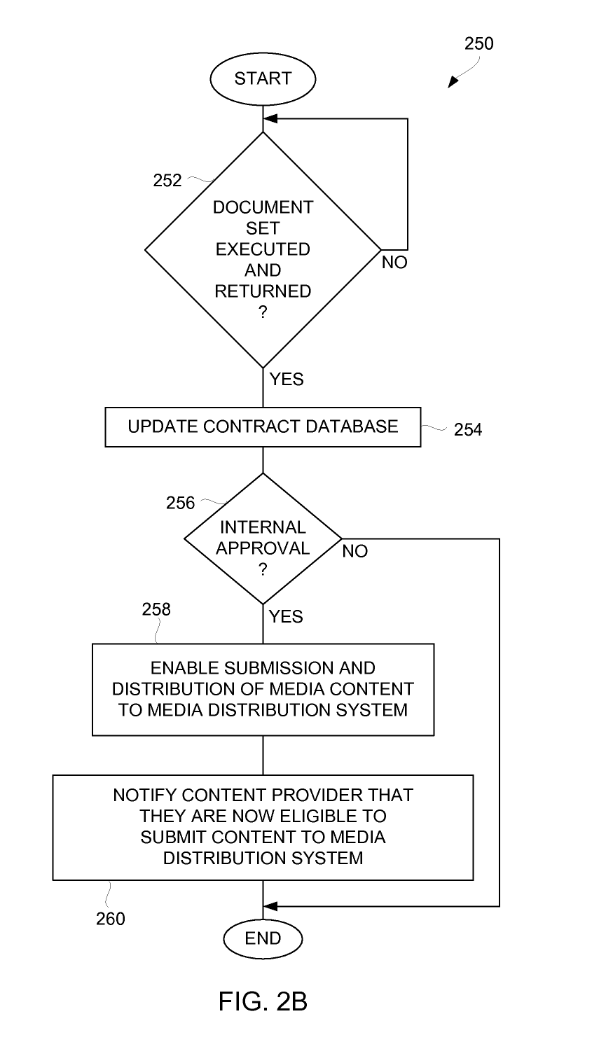

FIG. 2A is a flow diagram of a contract delivery process 200 according to one embodiment of the invention. The contract delivery process 200 concerns formation of a contract (media contract) between a content provider and a media distribution system. The contract governs distribution of media (media content) by the media distribution system. The contract delivery process 200 is, for example, performed by a contract management system, such as the contract management system 114 illustrated in FIG. 1A.

The contract delivery process 200 initially invites 202 a content provider to utilize a media distribution system to distribute media content. The media distribution system is, for example, the media distribution system 102 illustrated in FIG. 1A. Typically, the media distribution system supports an online media store from which media content provided by the content provider can be made available for purchase. Hence, the content provider is being invited 202 to provide media content to the media distribution system. In this embodiment, the content providers are being invited to participate and those that are invited can request a media contract with the media distribution system.

After the content provider has been invited 202, a decision 204 determines whether a media contract request has been received. Here, the content provider can initiate a media contract request with the media distribution system. A media contract can also be referred to as a media distribution agreement. In one embodiment, the media content request specifies the type of contract being requested and identifies the content provider. The media distribution system may require that the contract request include additional information about the content provider. The media distribution system may also already have access to additional information pertaining to the content provider (e.g., account information, etc.). When the decision 204 determines that a media contract has not yet been requested, the contract delivery process 200 awaits such a request.

Once the decision 204 determines that a media contract has been requested, a document set to be utilized with the media contract request is determined 206. In one implementation, the document set pertains to a plurality of documents that are associated with a media contract. For example, the document set can include a media contract, tax related forms, and bank forms. In one embodiment, the document set being determined 206 is dependent on a particular type of media contract being requested. Next, the document set is personalized 208 for the content provider. In this regard, the documents within the document set can be completed for use by the content provider. For example, the name, physical address, email address, etc. of the content provider can be inserted into the appropriate regions of one or more documents in the document set. While the personalization of the document set at this point may only partially complete the various open fields of the documents that need to be completed, other information can be later provided by the content provider. The media contract can also indicate and/or be associated with a unique contract number that has been assigned to the contract. In addition, the contract number can be linked to the content provider.

Next, document information corresponding to the personalized document set is stored 210 into a contract database. The contract database thus maintains a record of the status and characteristics of the media contract. In this case, although the media contract is not yet in effect, the status and characteristics of the media contract are stored in the contract database. The personalized document set is then sent 212 to the content provider. Typically, the personalized document set is transmitted electronically to the content provider. For example, the personalized document set can be sent as an attachment to an electronic mail message that is sent to the content provider. After the personalized document set has been sent 212 to the content provider, the contract delivery process 200 ends.

After the content provider receives the personalized document set, the content provider reads and completes the various documents in the document set. Although the documents in the document set have been personalized at least to a limited extent for the content provider, the documents typically require further completion by the content provider. The content provider can complete the documents through hand-written modifications to printed versions of the documents or through electronic completion of the documents as electronic documents. Alternatively, the system could require that the media contract request provide further information concerning the content provider at an early stage of the process so that the documents in the document set can be further personalized in an automated fashion before being sent to the content provider, thereby reducing or eliminating the need for the content provider to modify the documents being provided.

In an alternative embodiment, the content provider can be provided with the document set by directing the content provider to a particular network address where the document set can be accessed. The content provider can then complete the documents of the document set online (e.g., online forms). Then, to the extent that the documents need to be signed by the content provider, the documents can be printed and then physically signed or the documents can be electronically signed.

Although the embodiment illustrated in FIG. 2A is initiated by way of an invitation, in other embodiments, content providers can be permitted to request contracts without being invited. For example, when a content provider accesses the contract management system, the system can present the content provider with information on available contract opportunities. The available contract opportunities can include contract upgrades or extensions. For example, a contract extension can add contractual coverage for additional territories or countries, and a contract upgrade can add contractual coverage for an additional media type.

FIG. 2B is a flow diagram of a contract completion process 250 according to one embodiment of the invention. The contract completion process 250 follows from the contract delivery process 200 illustrated in FIG. 2A. The contract completion process 250 is, for example, performed by a contract management system, such as the contract management system 114 illustrated in FIG. 1A.

The contract completion process 250 begins with a decision 252. The decision 252 determines whether the document set (previously provided to a content provider) has been executed and returned. When the decision 252 determines that the document set has not yet been executed and returned, the contract completion process 250 awaits the return of the document set. On the other hand, once the decision 252 determines that the document set has been executed and returned, the contract completion process 250 proceeds. In other words, the contract completion process 250 can be deemed to be invoked once a document set has been executed and returned to the contract management system.

Once the contract completion process 250 has received a document set that has been executed and returned, the contract database is updated 254. For example, the contract database can be updated 254 to include a status update for the document set. As an example, the status of the contract or document set can be indicated as being “returned”. The contract database may also include text and/or images of the documents of the document set. Upon review of the document set, additional information pertaining to the document set can be stored in the contract database.

Next, a decision 256 determines whether internal approval of the media contract has been provided. The internal approval is, for example, provided by a representative of the media distribution system. The internal approval can determine whether the media contract is to be accepted. When the decision 256 determines that internal approval has been provided, the submission and distribution of media content to the media distribution system is enabled 258. This enablement of submission and distribution of media content can be performed by denoting such in the contract database. The media distribution system can then access the contract database to determine whether media content being offered for distribution is covered by a media contract that is effective and characterized in the contract database. Following the block 258, the content provider is notified 260 that they are now eligible to submit content to the media distribution system. For example, an electronic notification (such an electronic mail message) can be sent to the content provider.

On the other hand, when the decision 256 determines that internal approval has not yet been provided, the blocks 258 and 260 are not performed (i.e., bypassed). In this case, submission and distribution of media content provided by the content provider is not yet enabled. However, subsequently, the internal approval could be provided so that the content provider would be eligible to submit content to the media distribution system. Following the block 260, or following the decision 256 when internal approval is not provided, the contract completion process 250 ends.

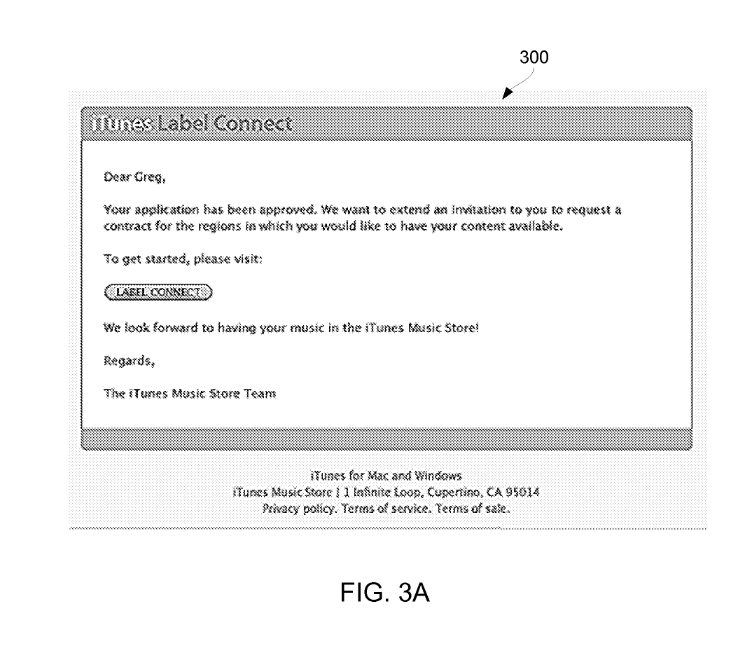

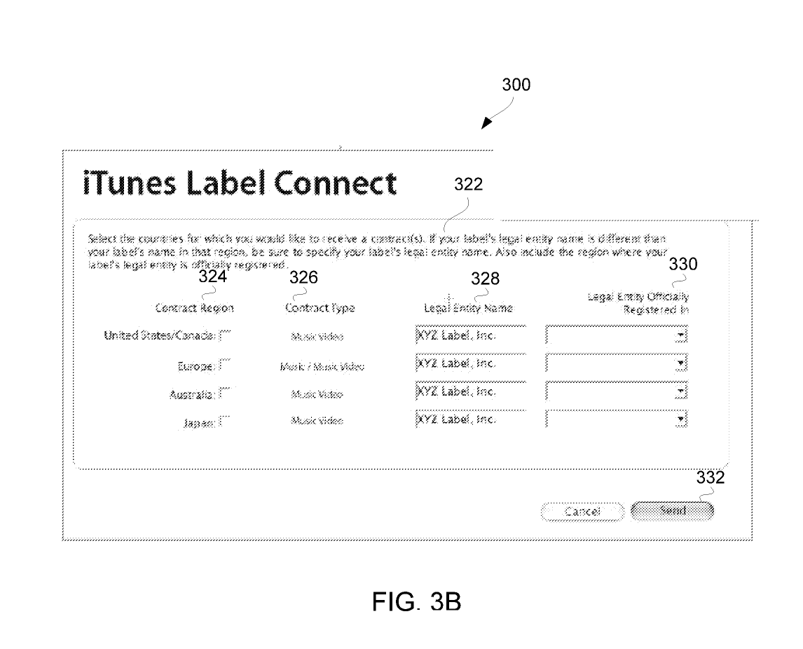

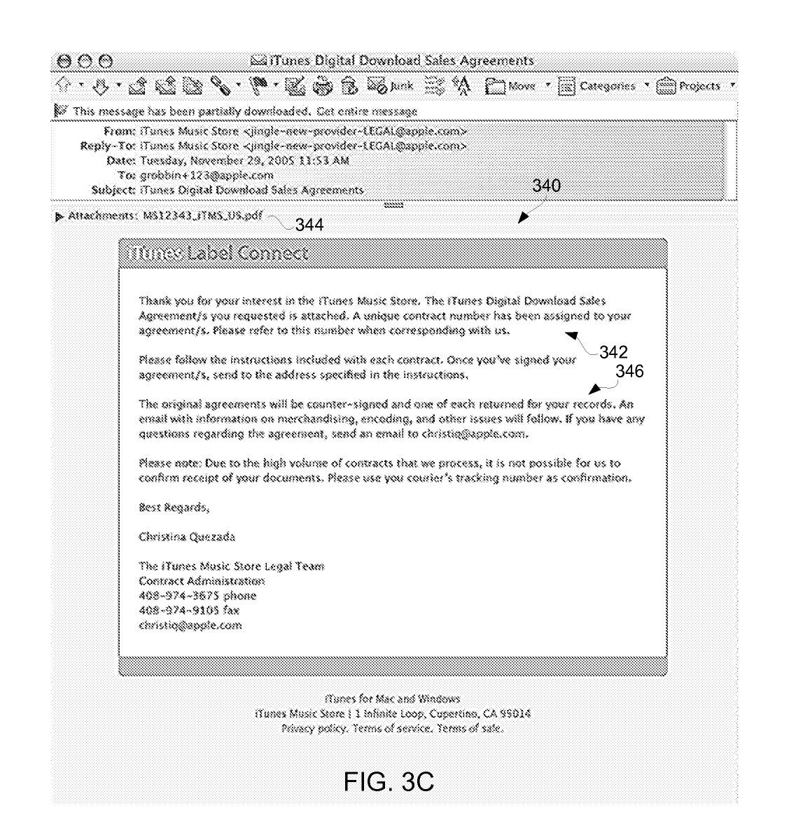

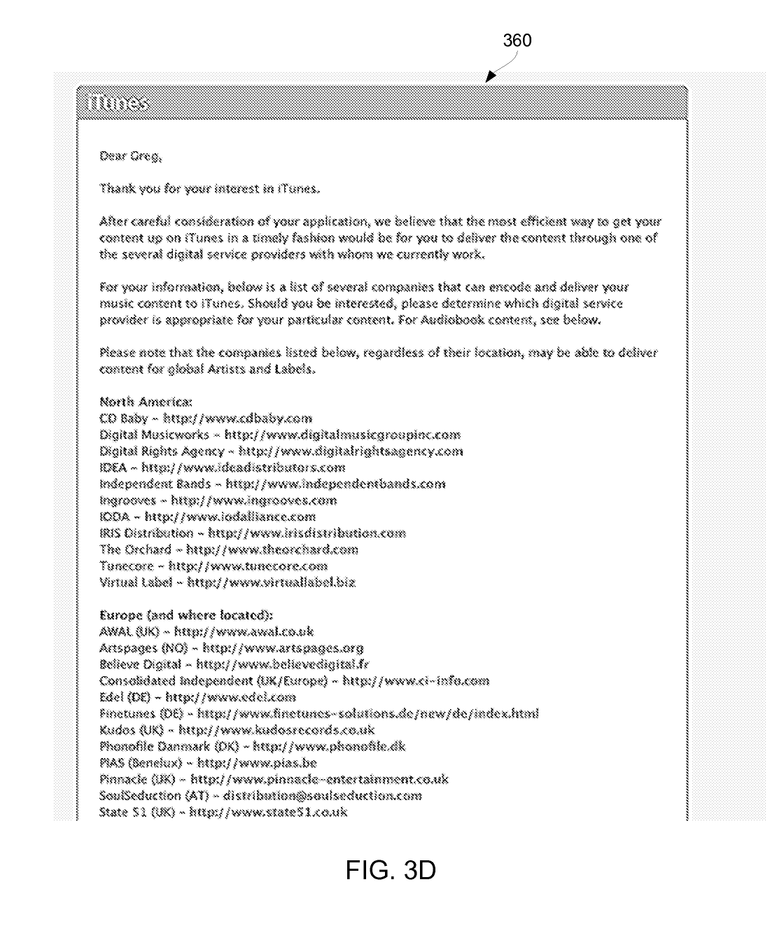

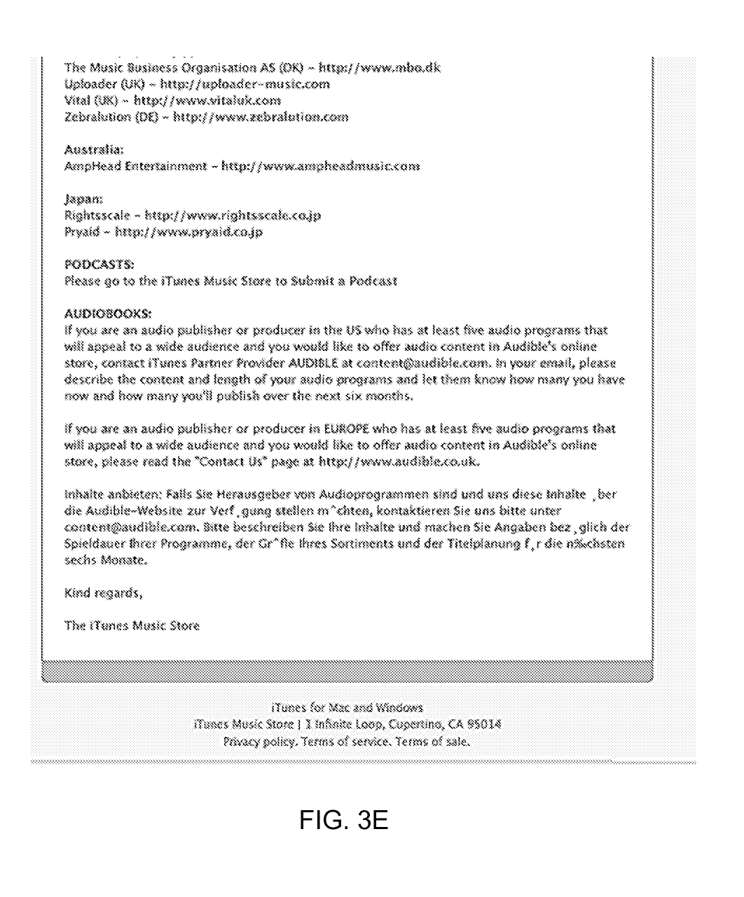

FIG. 3A illustrates an exemplary e-mail message 300 that can be sent to a content provider (i.e., user) to invite the content provider to apply for usage of the media distribution system. Here, in applying for usage, the content provider requests a contract for a particular region that the content provider desires to have media content distributed by the media distribution system. If the content provider accepts the invitation to apply, then the user accesses a contract management system. In this example, the contract management system is denoted “Label Connect.” Label Connect can not only provide contract management but also provide other tools to assist content providers with submitting digital content to a media distribution system (such as a digital content distributor). In this example, the digital content distributor is Apple Computer, Inc., who distributes media via their online media store. One available tool (e.g., iTunesProducer) available from Label Connect assists a content provider with submitting media content.

FIG. 3B illustrates an exemplary contract request screen 320 according to one embodiment of the invention. When a content provider accesses the contract management system to request a contract for distribution of media content, the exemplary contract request screen 320 can be presented to the content provider. The content provider can access the contract management system using a network browser or an application program supporting network access. In general, using the contract request screen 320, the content provider can indicate in which territories or regions they would like a contract. The contract request can also be for different types of content, such as music, videos, video and music, etc. Different content types can be available in different territories or regions. The type of content that is available can be dependent on the region or territory, existing contracts the content provider already has, and/or content types being offered by the contract management system. In particular, the contract request screen illustrated in FIG. 3B includes contract request instructions 322 and a listing of available contracts that can be requested. The list of available contracts can be dependent on one or more of: the content provider, the media distribution system, and existing contracts. In this example, the listing of available contracts includes a contract region 324, a contract type 326, a legal entity name 328, and a legal entity officially registered in area 330. More specifically, as shown in FIG. 3B, the content provider can request any of four available contracts. The contract region 324 for the four available contracts are “United States/Canada”, “Europe”, “Australia” and “Japan”. The contract type 326 for the four existing contracts is either “Music Video” which covers music and video or “Music/Music Video” which covers both music and music videos. To start the contract request, the content provider selects one or more of the four available contracts and then selects a “Send” button 332 to request the one or more selected contracts.

FIG. 3C illustrates a representative e-mail message 340 that can be sent to a contract provider when they are approved for a new contract (e.g., sales agreement). Here, the e-mail message 340 includes contract information 342 that informs the content provider that they have been approved. In addition, the e-mail message 340 can enclose a document set 344 that has been created for the content provider. In this example, the contract is a PDF file. The document set 344 can include not only the contract for the one or more territories and one or more content types but also any other supporting documents that may be required (e.g., banking information, taxpayer identification number forms, etc.). The e-mail message 340 further includes contract completion instructions 346 that inform the content provider on how to properly complete and return some or all of the document set.

FIGS. 3D and 3E illustrate a representative e-mail message 360 sent to a content provider (applicant). In this case, the content provider was not accepted for direct submission of media content to the media distribution system (e.g., digital content distributor). Instead, the content provider is encouraged to use an authorized third-party to deliver their media content to the media distribution system.

According to another aspect, a contract management system processes and manages renewal of media contracts. According to one embodiment of the invention, the renewal process for content providers can be provided by a contract management system. The contract management system can start reminding current contract holders a predetermined number of days (e.g., 100 days) prior to expiration of their existing contracts. The initial reminders alert the contract providers that they need to update their contract. When the content providers want to update their contract, they can interact with the online contract management system (e.g., Label Connect) to request contract renewals. Here, a content provider can request a contract for a particular region, and then as noted above, the contract (if approved by business or legal representatives) can cause the contract management system to produce a contract that can be provided to the user. Subsequently, when the contract is executed and returned, the contract management system can update a database to indicate that the content provider is now under a renewed contract.

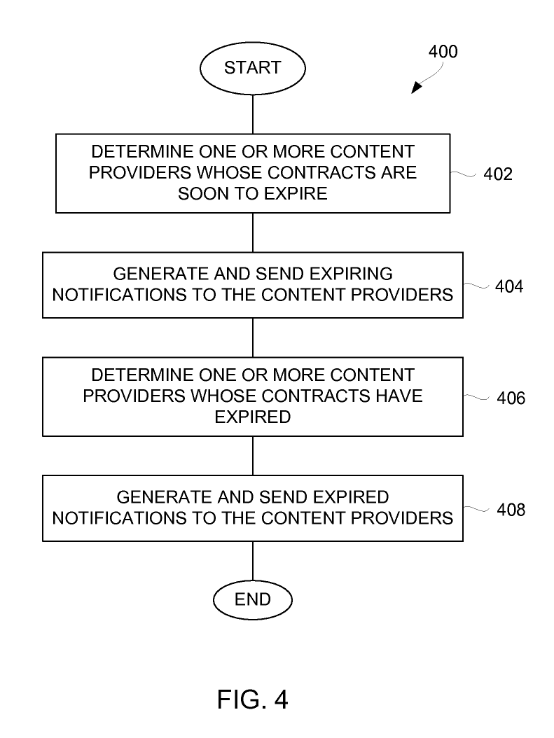

FIG. 4 is a flow diagram of a contract renewal notification process 400 according to one embodiment of the invention. The contract renewal notification process 400 operates to notify content providers that their contracts (media contracts) are approaching their expiration date. As a result, content providers are encouraged to take action to renew their contracts so that media content associated with such content providers can continue to be authorized for submission and distribution by appropriate contracts.

The contract renewal notification process 400 determines 402 one or more content providers whose contracts are soon to expire. As an example, the contract renewal notification process 400 can access a contract database to determine the one or more content providers whose contracts are soon to expire. Next, expiration notifications are generated and sent 404 to the content providers. The expiration notifications inform the content providers that their contracts are soon to expire and they should take appropriate action to renew such contracts. As an example, the expiration notifications can be electronic mail messages that are sent to the content providers.

In addition, the contract renewal notification process 400 can also inform content providers that their contracts have expired. Hence, the contract renewal notification process 400 also determines 406 one or more content providers whose contracts have expired. For such content providers, expired notifications are generated and sent 408 to the content providers. As an example, the expired notifications can be electronic mail messages that are sent to the content providers. Following the block 408, the contract renewal notification process 400 ends.

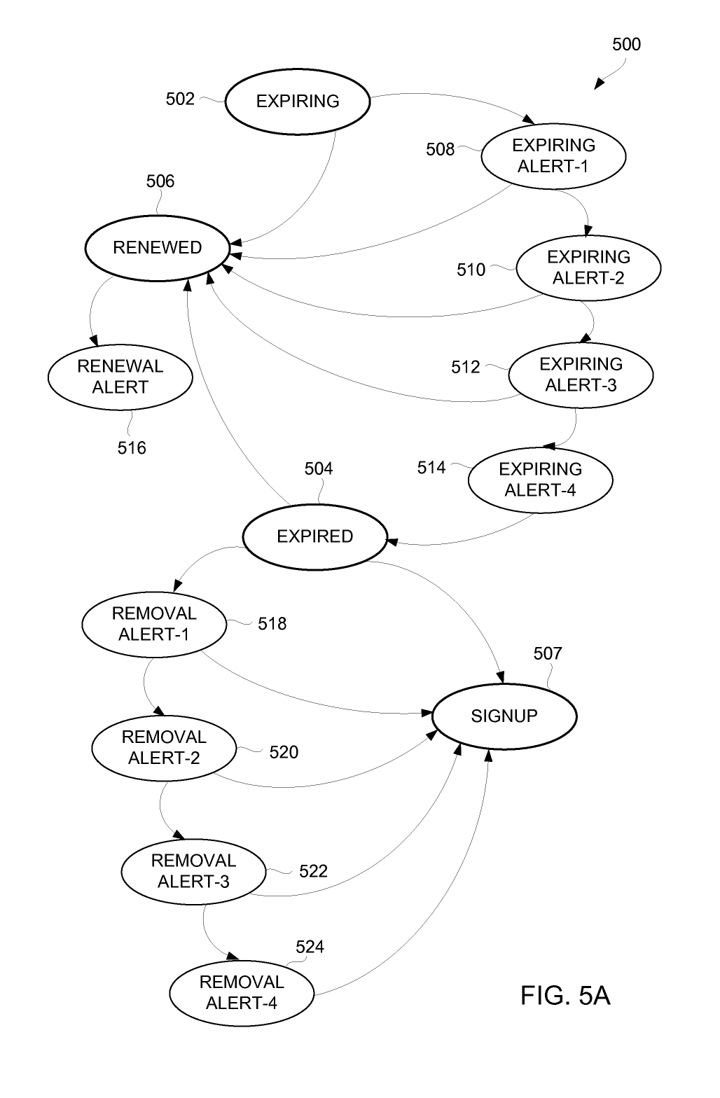

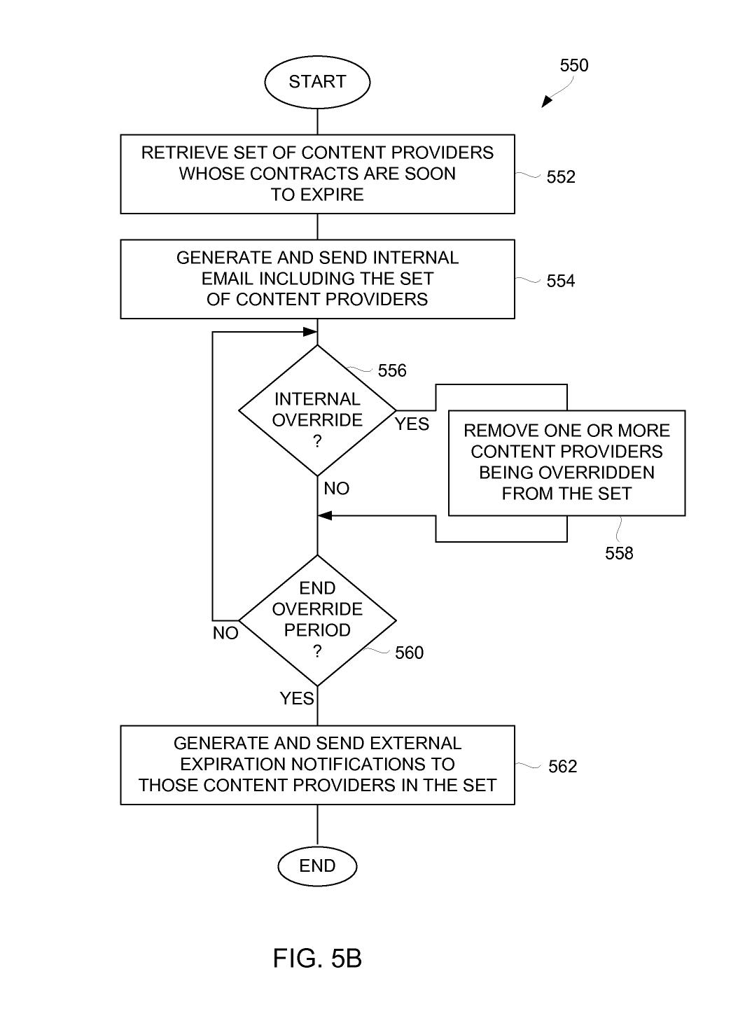

FIG. 5A is a diagram of a retrieval notification system 500 according to one embodiment of the invention. The retrieval notification system 500 illustrates a series of contract states as well as a series of different notifications that can be produced and provided to content providers. In particular, the renewal notification system 500 indicates four states for a contract once a contract has been formed. These states include a expiring state 502, an expired state 504, a renewed state 506, and a signup state 507. A contract can be placed in the expiring state 502 when the contract is not yet expired but is approaching its expiration date. In this case, the content provider associated with the expiring contract is alerted (or notified) through a series of electronic mail messages. Specifically, a first expiring alert 508 can be provided to the content provider 90 days prior to expiration of the contract. Next, a second expiring alert 510 can be provided to the content provider 30 days prior to expiration. Still further, a third expiring alert 512 can be provided to the content provider 10 days prior to expiration. Still further, a fourth expiring alert 514 can be provided to the content provider 1 day prior to expiration. Each of the expiring alerts 508-514 can inform the content provider that their contract will expire shortly and that the contract should be renewed in order to avoid expiration of the contract. The content provider can, in response to an expiring alert or otherwise, interact with the system to renew the contract.

In the event that the content provider does not take any action to renew the contract, the contract enters the expired state 504. When the contract is in the expired state 504, the contract no longer authorizes the submission and/or distribution of media content associated with the content provider. Hence, a media distribution system using the contract will typically cease selling the media content associated with the content provider already provided to the media distribution system. In addition, the media distribution may also prevent submission of media content from the content provider having the expired contract. In one embodiment, when the contract for a content provider has expired, the media distribution system automatically (i) ceases selling the media content that is no longer covered by an active contract, and (ii) prevents submission of media content to the media distribution system. A given content provider can have multiple contracts with the media distribution system such that some content of the content provider can continue to be sold even though other content is prevent from being sold.

To continue to have the media distribution system distribute media content associated with the content provider, the content provider must take action to renew their one or more contracts with the media distribution system. Hence, the contract state can either transition from the expiring state 502 to the expired state 504 or to a renewed state 506. The contract that is renewed can be considered in the renewed state. In the event that the contract is renewed, the contract enters the renewed state 506. Once the contract is renewed, a renewal alert 516 can be sent to the content provider. The renewal alert 516 can inform the content provider that their contract has been renewed and that their content can continue to be distributed by the media distribution system. However, even though the contract has been renewed, in the future the renewed contract will become an expiring contract when it is soon to reach its expiration date.

In addition, when the contract is in the expired state 504, and the content provider has not taken action to renew the contract, a series of removal alerts can be provided to the content provider. The removal alerts operate to inform content providers of the expired nature of their contract and their loss of distribution ability with respect to the media distribution system. In particular, as shown in FIG. 5A, a first removal alert 518 can be provided to the content provider on the day that the contract expires. A second removal alert 520 can be provided to the content provider the day after the contract expires. A third removal alert 522 can be provided to the content provider the second day after the contract expires. A fourth removal alert 524 can be provided to the content provider a third day after the contract has expired. In the event that the expired contract is to be replaced by a new contract prior to the timing of the removal alerts 518-524, the contract is placed in the signup state 507 and any subsequent removal alerts would not be sent to the content provider. At the signup state 507, the content provider can proceed to sign a new contract for media distribution.

FIG. 5B is a flow diagram of a renewal notification process 550. The renewal notification process 550 is, for example, performed by a contract management system, such as the contract management system 114 illustrated in FIG. 1A.

The renewal notification process 550 initially retrieves 552 a set of content providers whose contracts are soon to expire. For example, contracts can be considered soon to inspire if they are within a predetermined number of days (e.g., 90, 60, 30 or 10 days) prior to their expiration date. After the set of content providers has been retrieved 552, an internal e-mail including the set of content providers is generated and sent 554. The e-mail can be sent to one or more representatives (i.e., persons) associated with a media distribution system that are involved with contract management. The e-mail enables the representatives that receive the e-mail to invoke an internal override. Next, a decision 556 determines whether an internal override has been issued. Here, an internal override can be issued by a representative of a media distribution system anytime during an override window. The override window is typically a number of days (e.g., 3 days). When the decision 556 determines that an internal override is present, one or more content providers are removed 558 from the set of content providers. That is, if an internal override is requested, the internal override operates to remove a specific content provider from the set of content providers.

Following block 558, as well as directly following the decision 556 when an internal override has not been issued, a decision 560 determines whether an override window has ended. The override window is a period of time after the internal e-mails are sent 554 during which an internal override can be provided. When the decision 560 determines that the override period has not ended, the renewal notification process 550 returns to repeat the decision 556 and subsequent blocks. On the other hand, once the decision 560 determines that the override has ended, external expiration notifications are generated and sent to those content providers still in the set of content providers. Following the block 562, the renewal notification process 550 ends.

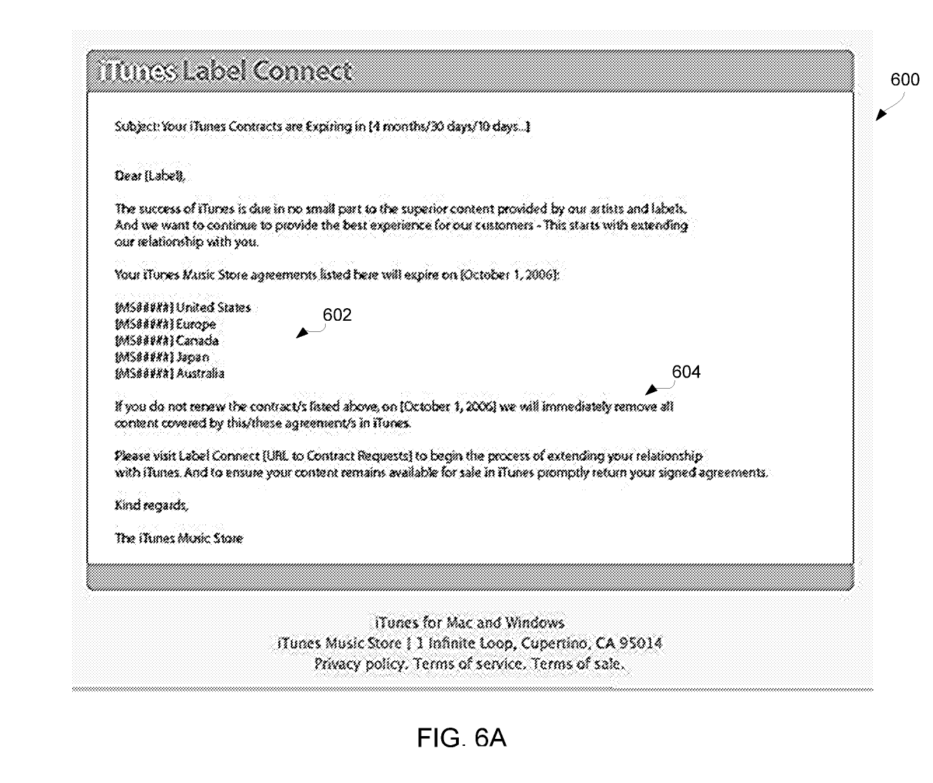

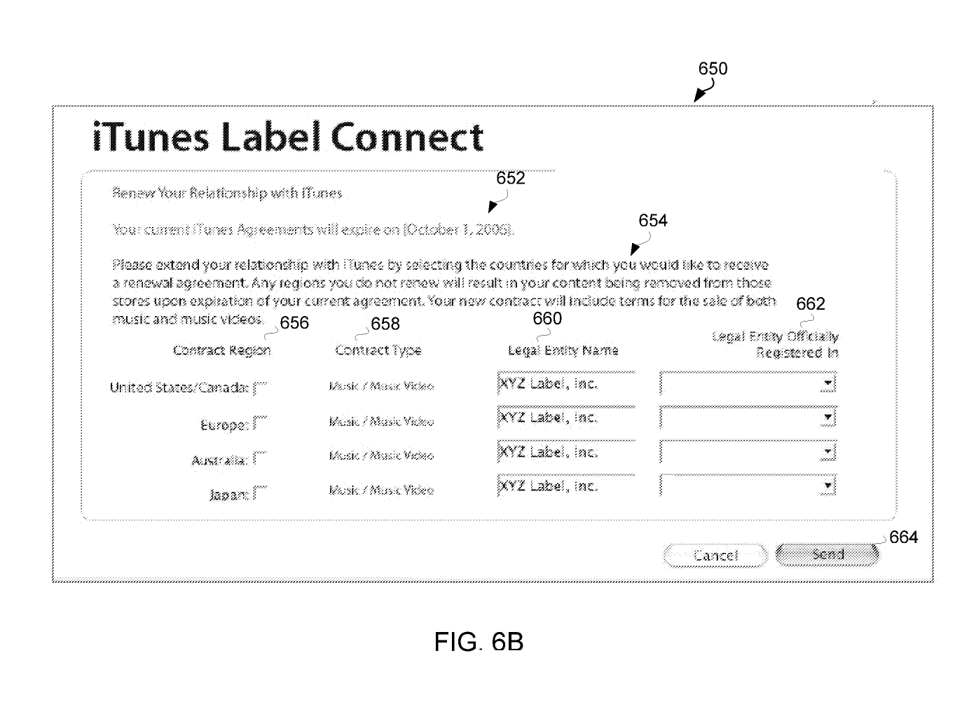

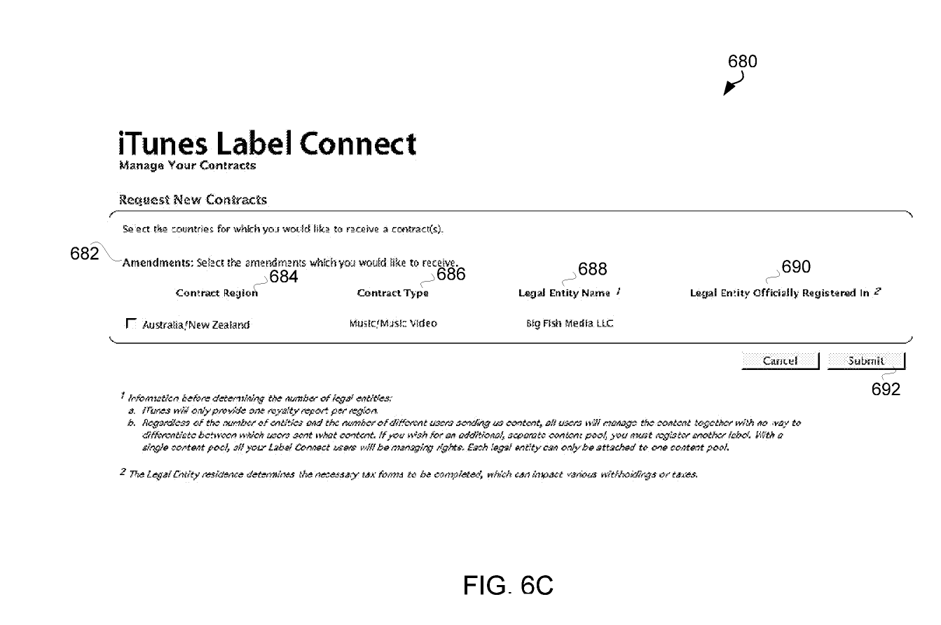

FIG. 6A is an exemplary e-mail message 600 that can be sent to a content provider (i.e., user) to inform them that one or more of their existing contracts are due to expire in several months. The e-mail message 600 informs the content provider of the particular contracts 602 that are soon to expire. The e-mail message 600 also specifically provides a warning 604 to the content provider that upon expiration of a contract, distribution of all the media content covered by the expired contract will cease. The e-mail message 600 can also provide a reference or hyperlink to the contract management system so that the content provider can easily request contract renewals.

FIG. 6B is an exemplary contract renewal screen 650 according to one embodiment of the invention. When a content provider accesses the contract management system, the exemplary contract renewal screen 650 can be presented to the content provider. The content provider can access the contract management system using a network browser or application program supporting network access. In general, using the contract renewal screen 650, the content provider can indicate those territories or regions for which they would like a renewal contract. The renewal contract(s) can also be for different types of content, such as music, videos, video and music, etc. In particular, the contract renewal screen illustrated in FIG. 6B includes an expiration warning 652, renewal instructions 654, and a listing of existing contracts that can be renewed. In this example, the listing of existing contracts includes a contract region 656, a contract type 658, a legal entity name 660, and a legal entity officially registered in area 662. More specifically, as shown in FIG. 6B, the content provider can renew any of the four existing contracts that expire on Oct. 1, 2006. The contract region 656 for the four existing contracts are “United States/Canada”, “Europe”, “Australia” and “Japan”. The contract type 658 for the four existing contracts is “Music/Music Video” which covers both music and music videos. To start the contract renewal, the content provider selects one or more of the four existing contracts and then selects a “Send” button 664 to request renewal of the one or more selected contracts.

Besides renewal of one or more existing contracts, a content provider can also upgrade from an existing contract to an expanded contract. An expanded contract can be expanded in terms of countries (e.g., territories) or in terms of content types being covered by the contract. A content provider can be offered such upgrades through notifications or when accessing the contract management system.

FIG. 6C is an exemplary contract amendment screen 680 according to one embodiment of the invention. When a content provider accesses the contract management system, the exemplary contract amendment screen 680 can be presented to the content provider. The content provider can access the contract management system using a network browser or application program supporting network access. In an amendment section 682, the contract amendment screen 680 can offer one or more contractual upgrades, namely, amendments that the content provider is eligible to obtain. Examples of amendments are contractual agreements to extend contractual coverage to additional countries (or territories) or to extend contractual coverall to additional media types. The content provider can then select any of the offered amendments that they wish to enter. For each of the available amendments, the amendment section 682 can include information on a contract region 684, a contract type 686, a legal entity name 688, and a legal entity officially registered in area 690. To start the contractual amendment, the content provider selects one or more of the available amendments and then selects a “Submit” button 692 to request the one or more selected amendments from the contract management system.

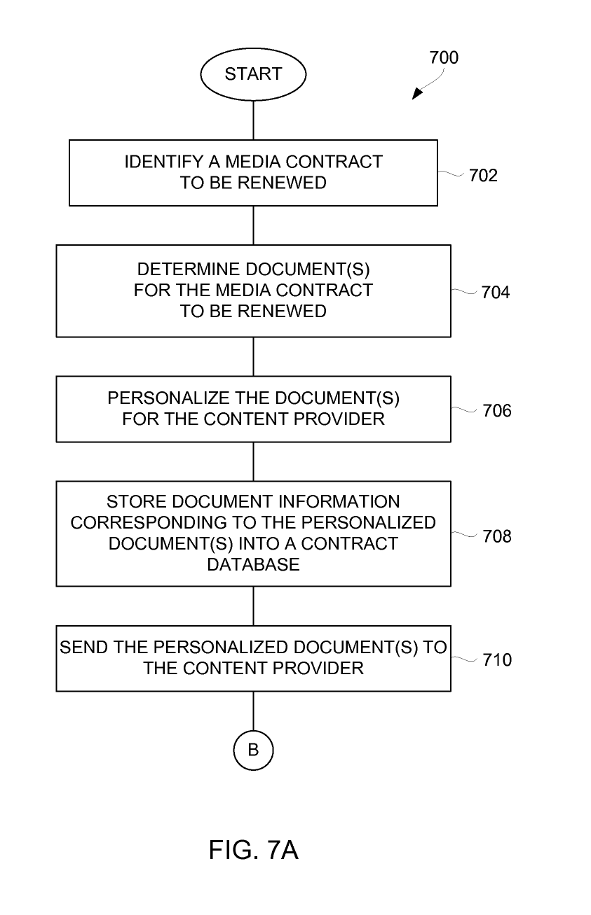

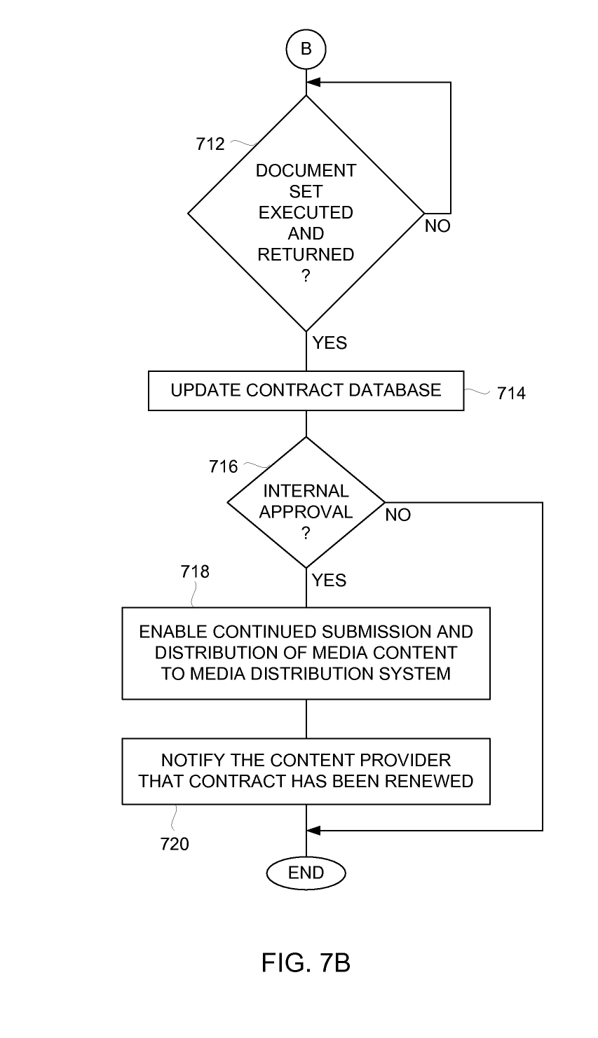

FIGS. 7A and 7B are flow diagrams of a contract renewal process 700 according to one embodiment of the invention. The contract renewal process 700 concerns renewal of a contract, namely, a media contract, with a contract management system so that a media distribution system associated therewith can continue to distribute media associated with content providers.

The contract renewal process 700 initially identifies 702 at least one contract to be renewed. Each of the contracts being identified 702 is associated with a content provider. Each content provider can have one or more contracts that need to be renewed. After a media contract has been identified 702, one or more documents for renewal of the media contract to be renewed are determined 704. The one or more documents includes at least a renewal contract. In one implementation, the one or more documents form a document set. The one or more documents for the content provider can then be personalized 706. Here, since the contract management system already knows certain information pertaining to the content provider that is required for the one or more documents, the one or more documents can be automatically modified to include such information. Next, document information corresponding to the one or more personalized documents can be stored 708 into a contract database. Hence, the characteristics of the documents within the document set can be stored to the contract database. Next, the one or more personalized documents are sent 710 to the content provider.

A decision 712 then determines whether the documents have been executed and returned by the content provider. When the decision 712 determines that the document set has been executed and returned, the contract renewal process 700 continues. When the contract renewal process 700 continues, the contract database is updated 714. The contract database can be updated 714 to include additional characteristics associated with the document set after being completed by the content provider. The contract database can also be updated 714 to alter the status of the renewal contract. For example, once the document corresponding to the renewal contract has been executed and returned, the status of the renewal contract can be “received” or “returned.”

Next, a decision 716 determines whether internal approval has accepted the renewal contract. In this embodiment, internal approval of a renewal contract is required in order for the renewal contract to be accepted by the media distribution system. When the decision 716 determines that internal approval has been provided, the renewal contract is accepted. In such case, continued submission and distribution of media content by the content provider to the media distribution system is enabled 718. In other words, the prior contract is now replaced by the renewed contract and the distribution of media content continues under the renewed contract. If the prior contract has not yet expired, then the renewal contract can take effect upon expiration of the prior contract. Alternatively, if the prior contract has not yet expired, then the renewal contract can take effect immediately upon completion of the renewal contract. In any case, if the prior contract is renewed before actual expiration, then media content from the content provider can remain available (i.e., continuously) from the media distribution system. If the prior contract expired, the submission and distribution of media content can be re-enabled for the content provider. In any case, the content provider can then be notified 720 that their contract has been renewed. On the other hand, when the decision 716 determines that the internal approval is denied, the blocks 718 and 720 are bypassed such that submission and distribution of media content is not re-enabled. Following the block 720, or its being bypassed, the contract renewal process 700 ends.

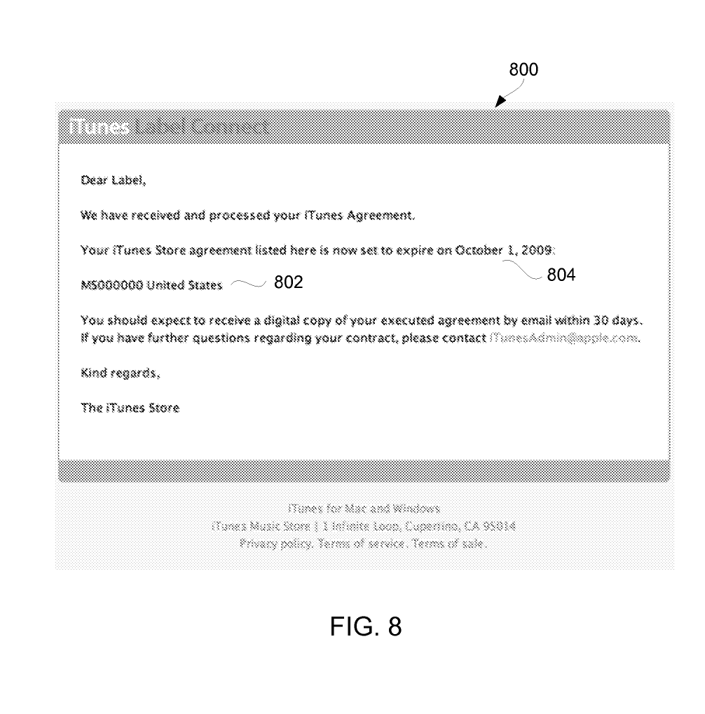

FIG. 8 is an exemplary e-mail message 800 that can be sent to a content provider (i.e., user) to inform them that one or more of their existing contracts has been successfully renewed. The e-mail message 800 informs the content provider of the particular contract 802 that has been renewed. The e-mail message 800 also informs the content provider of the expiration date 804 of the newly renewed contract.

The various aspects, features, embodiments or implementations of the invention described above can be used alone or in various combinations.

Although the media assets (or media items) of emphasis in several of the above embodiments were audio items (e.g., songs, audio files or audio tracks), the media assets are not limited to audio items. For example, the media assets can alternatively pertain to videos (e.g., movies, television shows), podcasts, audiobooks, and/or images (e.g., photos).

The invention is preferably implemented by software, but can also be implemented in hardware or a combination of hardware and software. The invention can also be embodied as computer readable code on a computer readable medium. The computer readable medium is any data storage device that can store data which can thereafter be read by a computer system. Examples of the computer readable media include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The advantages of the invention are numerous. Different embodiments or implementations may, but need not, yield one or more of the following advantages. One advantage of the invention is that contract formation and/or contract renewal can be substantially automated. Another advantage of the invention is that contract status can be integrated with and utilized by a media distribution system.

The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer-implemented method for automated processing of media contracts for a media content provider and a media distribution system, said method comprising:
(a) receiving a media contract request from a media content provider;
(b) determining a document set to be utilized for the media contract request;
(c) personalizing the document set for the content provider; and
(d) sending the personalized document set to the content provider.

2. A computer-implemented method as recited in claim 1, wherein said method further comprises:
(e) storing document information concerning the personalized document set into a database associated with the media distribution system.

3. A computer-implemented method as recited in claim 2, wherein the document information is descriptive of one or more of the documents in the personalized document set.

4. A computer-implemented method as recited in claim 2, wherein said method further comprises:
(f) updating the database when the personalized document set is executed and returned; and
(g) enabling, subsequent to said updating (f), submission and distribution of media content to the media distribution system.

5. A computer-implemented method as recited in claim 4, wherein said updating (f) changes a contract state stored in the database.

6. A computer-implemented method as recited in claim 4, wherein said method further comprises:
(h) notifying, subsequent to said updating (f) or said enabling (g), the content provider that they are eligible to submit content to the media distribution system for distribution.

7. A computer-implemented method as recited in claim 4, wherein said enabling (g) is dependent on receiving an approval from a representative of the media distribution system.

8. A computer-implemented method as recited in claim 2, wherein, following said sending (d), the database is updated to indicate that the personalized document set has been sent to the content provider.

9. A computer-implemented method as recited in claim 2, wherein the document information being stored in the database includes a state of the personalized document set.

10. A computer-implemented method for notifying a content provider to renew a media contract with a media distribution system, said method comprising:
(a) determining at least one content provider having at least one contract that is soon to expire;
(b) producing a notification message to inform the content provider that the contract is soon to expire unless renewed; and
(c) sending the notification message to the content provider.

11. A computer-implemented method as recited in claim 10, wherein the notification message includes an indication of an existing contact and an indication of when an existing contract is scheduled to expire.

12. A computer-implemented method as recited in claim 10, wherein said computer-implemented method operates to automatically send the content provider a plurality of notification messages to encourage the content provider to renew the contract.

13. A computer-implemented method as recited in claim 10, wherein the contract has an expiration date, and
wherein the notification messages are automatically sent at predetermined time periods with reference to the expiration date of the contract.

14. A computer-implemented method for renewing media contracts between content providers and a media distribution system, said method comprising:
(a) identifying at least one media contract to be renewed, the media contract being between a content provider and the media distribution system;
(b) determining a document set for renewal of the at least one media contract to be renewed;
(c) personalizing the document set for the content provider;
(d) sending the personalized document set to the content provider;
(e) storing document information corresponding to the personalized document set into a contract database;
(f) updating the database when the personalized document set is executed and returned;
(g) enabling, subsequent to said updating (f), submission and distribution of media content to the media distribution system; and
(h) notifying, subsequent to said enabling (g), the content provider that they are eligible to submit content to the media distribution system for distribution.

15. A computer-implemented method as recited in claim 14, wherein the document information is descriptive of one or more of the documents in the personalized document set.

16. A computer-implemented method as recited in claim 14, wherein said updating (f) changes a contract state stored in the database.

17. A computer-implemented method as recited in claim 14, wherein said enabling (g) is dependent on receiving an approval from a representative of the media distribution system.

18. A computer-implemented method as recited in claim 14, wherein, following said sending (d), the database is updated to indicate that the personalized document set has been sent to the content provider.

19. A computer-implemented method as recited in claim 14, wherein the document information being stored in the database includes a state of the personalized document set.

20. A computer-implemented method as recited in claim 14, wherein said identifying (a) comprises accessing the database to determine those existing contracts that are soon to expire.

21. A graphical user interface for renewing a contract, said graphical user interface comprising:
an expiration warning area that presents an expiration warning;
renewal instructions area that presents renewal instructions; and
a listing of one or more existing contracts that can be renewed,
wherein, for each of the existing contracts in the listing, the listing of existing contracts includes a contract region and a contract type.

22. A graphical user interface as recited in claim 21, wherein the expiration warning includes at least one expiration date for the one or more existing contracts.

23. A graphical user interface as recited in claim 21, wherein the contract region corresponds to a country or territory, and wherein the contract type corresponds to a particular type of media.

24. A computer readable medium including at least computer program code for automated processing of media distribution agreements between a media content provider and a media distribution system, said computer readable medium comprising:
computer program code for receiving a media distribution agreement request from a media content provider;
computer program code for determining a media contract to be utilized for the media distribution agreement request;
computer program code for personalizing the media contract for the content provider; and
computer program code for sending the personalized media contract to the content provider.

25. A computer readable medium as recited in claim 24, wherein said computer readable medium further comprises:
computer program code for storing document information concerning the personalized media contract into a database associated with the media distribution system.
computer program code for updating the database when the personalized media contract is executed and returned; and
computer program code for enabling submission and distribution of media content to the media distribution system.

26. A computer readable medium as recited in claim 25,
wherein the document information is descriptive of the personalized media contract, and
wherein the document information being stored in the database includes a state of the personalized media contract.

27. A computer readable medium as recited in claim 25, wherein said computer program code for updating changes an agreement state stored in the database.

28. A computer readable medium as recited in claim 24, wherein said computer readable medium further comprises:
computer program code for notifying the content provider that they are eligible to submit content to the media distribution system for distribution.

29. A media management system for managing media content, said media management system comprising:
an agreement management system that manages media distribution agreements for said media management system; and
a media distribution system that manages electronic distribution of media content associated with content providers to purchasers over a network.

30. A media management system as recited in claim 29, wherein said agreement management system includes a notification manager configured to send notifications to those content providers with media distribution agreements that are soon to expire, thereby encouraging content providers with media distribution agreements to renew such agreements prior to their expiration.

31. A media management system as recited in claim 30, wherein said agreement management system further includes an agreement renewal manager configured to facilitate renewal of media distribution agreements prior to their expiration.

32. A media management system as recited in claim 30, wherein said agreement management system further includes an agreement expiration manager configured to indicate an expiration status when one or more of the media distribution agreements expire before being renewed.

33. A media management system as recited in claim 32, wherein when the expiration status indicates that a media distribution agreement is expired, then media content covered by the expired media distribution agreement is blocked from being distributed from said media distribution system.

34. A media management system as recited in claim 33, wherein the distribution of the media content covered by the expired media distribution agreement is unblocked once the content provider obtains a renewed media distribution agreement.

35. A media management system as recited in claim 29, wherein said media management system further comprises:
a database that stores agreement information on the media distribution agreements, the agreement information includes at least descriptive information and a status indication for each of the media distribution agreements.

36. A media management system as recited in claim 35, wherein the descriptive information includes at least information on: the content provider, covered media content, expiration date, and geographic scope of agreement.

37. A media management system as recited in claim 36, wherein the information on the covered media content indicates a type of media content being covered by the corresponding media distribution agreement.
